(19) United States
(12) Patent Application Publication
(10) Pub. No.: US 2009/0266378 A1
(43) Pub. Date: Oct. 29, 2009

(54) ULTRASONIC WAVE HAIR SET APPARATUS

(75) Inventor: Mahito Nunomura, Yawata-shi (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD.

(21) Appl. No.: 12/094,844

(22) PCT Filed: Nov. 16, 2006
(86) PCT No.: PCT/JP2006/322805

§ 371 Date: May 23, 2008

(30) Foreign Application Priority Data
Nov. 25, 2005 (JP) 2005-341251

(51) Int. Cl. A45D 2/40; B06B 1/02

(52) U.S. Cl. 132/224; 310/323.18; 132/271

(57) ABSTRACT

An ultrasonic wave hair set apparatus is configured by a main frame, an ultrasonic vibration block provided on the main frame, a pinching lever rotatably provided on the main frame, a presser plate provided on the pinching lever and having a pressing face. The ultrasonic vibration block is further comprised of an ultrasonic oscillator and an ultrasonic horn having a vibration face, and a comb shaped protection member is provided to enclose the vibration face. Even if a user penetrates a finger between the pinching lever and the main frame, the finger touches the protection member, so that it rarely touches the vibration face directly. Consequently, the ultrasonic vibrations are not transmitted to the finger, and burn injury can be prevented.

### TECHNICAL FIELD

The present invention relates to an ultrasonic wave hair set apparatus which is used to set hairs by pressing hairs to a vibration face performing ultrasonic vibration.

### BACKGROUND ART

For example, JPA 2000-333719 Official Gazette discloses a heat-type hair set apparatus that is used to set hairs. Such a heat-type hair set apparatus is provided a heating face heated by a heater on a main frame, and heats hairs by pressing the heating face to the hairs so as to set the hairs. The above mentioned heat-type hair set apparatus, however, has disadvantages that power consumption becomes larger, and it damages hairs because the heating face of a high temperature is pressed to the hairs.

Thus, an ultrasonic wave hair set apparatus is proposed so that it comprises a vibration face performing ultrasonic vibration instead of the heating face, and vibrates hairs when the hairs are pressed to the vibration face so as to set hairs by heating hairs from within by ultrasonic vibration.

If a portion of a human body other than hairs (typically, finger) touches the vibration face during vibrating by mistake, the ultrasonic wave hair set apparatus, however, has a disadvantage that the portion may be burned. In the conventional heat-type hair set apparatus, even if the finger touches the heating face, a user may generally take off the finger from the heating face reflectively, so that the finger is rarely burned. In contrast, when a finger touches the vibration face of the ultrasonic wave hair set apparatus, since the temperature of the vibration face is lower, the finger may rarely be taken off reflectively, and consequently, there is a possibility that the finger will be heated from within during touching the finger to the vibration face in a long time, and the finger may be burned.

### DISCLOSURE OF INVENTION

The present invention is conceived to solve the above mentioned problems of the prior art, and objected to provide an ultrasonic wave hair set apparatus that can prevent a portion of a human body other than hairs to touch the vibration face by mistake.

An ultrasonic wave hair set apparatus in accordance with an aspect of the present invention comprises a main frame, an ultrasonic vibration generating means which is provided on the main frame and generates ultrasonic vibrations, and a burn injury prevention means that prevent a portion of a human body other than hairs from touching to the vibration face of the ultrasonic wave generating means.

By providing the burn injury prevention means, even if a user touches a portion of a human body other than hairs such as a finger to the ultrasonic vibration generating means of the ultrasonic wave hair set apparatus in long time, the ultrasonic vibration may not be transmitted to the portion of the human body, so that the finger may not be heated from within and the finger may not be burnt injury.

### BRIEF DESCRIPTION OF DRAWINGS

FIG. 1 is a front view showing a configuration of an ultrasonic wave hair set apparatus in accordance with a first embodiment of the present invention.

FIG. 2 is a partially enlarged drawing showing the details of a comb shaped protection member in the ultrasonic wave hair set apparatus of the first embodiment.

FIG. 3A is a front view showing a condition that a pinching lever is opened from a main frame and a bundle of hairs is disposed between them in the ultrasonic wave hair set apparatus of the first embodiment. FIG. 3B is a front view showing a condition that the pinching lever is closed and the bundle of hairs is pinched between a vibration face and a pressing face. FIG. 3C is a top view showing a condition for setting hairs by moving the ultrasonic wave hair set apparatus.

FIG. 4A is a front view showing a condition that a user caught a finger between the vibration face and the pressing face of the ultrasonic wave hair set apparatus of the first embodiment. FIG. 4B is a front view showing a condition that the bundle of hairs is pinched between the vibration face and the pressing face of the ultrasonic wave hair set apparatus.

FIG. 5A is a side view showing a condition that the user caught the finger between the vibration face and the pressing face of the ultrasonic wave hair set apparatus of the first embodiment. FIG. 5B is a side view showing a condition that the bundle of hairs is pinched between the vibration face and the pressing face of the ultrasonic wave hair set apparatus.

FIG. 6A is a side view showing a configuration of an ultrasonic wave hair set apparatus in accordance with a second embodiment of the present invention and a condition that a user caught a finger between a vibration face and a pressing face. FIG. 6B is a side view showing a condition that a bundle of hairs is pinched between the vibration face and the pressing face of the ultrasonic wave hair set apparatus.

FIG. 7A is a front view showing a configuration of an ultrasonic wave hair set apparatus in accordance with a third embodiment of the present invention and a condition that a pinching lever is opened from a main frame and a bundle of hairs is disposed between them. FIG. 7B is a front view showing a condition that the pinching lever is closed and the bundle of hairs is pinched between a vibration face and a pressing face. FIG. 7C is a top view showing a condition that a user caught a finger between the vibration face and the pressing face of the ultrasonic wave hair set apparatus.

FIG. 8A is a front view showing a configuration of an ultrasonic wave hair set apparatus in accordance with a fourth embodiment of the present invention and a condition that a pinching lever is closed and a bundle of hairs is pinched between a vibration face and a pressing face of the ultrasonic wave hair set apparatus. FIG. 8B is a front view showing a condition that a user caught a finger between the vibration face and the pressing face of the ultrasonic wave hair set apparatus.

FIG. 9A is a front view showing a configuration of an ultrasonic wave hair set apparatus in accordance with a fifth embodiment of the present invention and a condition that a pinching lever is closed and a bundle of hairs is pinched between a vibration face and a pressing face. FIG. 9B is a front view showing a condition that the pinching lever is opened from a main frame of the ultrasonic wave hair set apparatus.

### BEST MODE FOR CARRYING OUT THE INVENTION

### First Embodiment

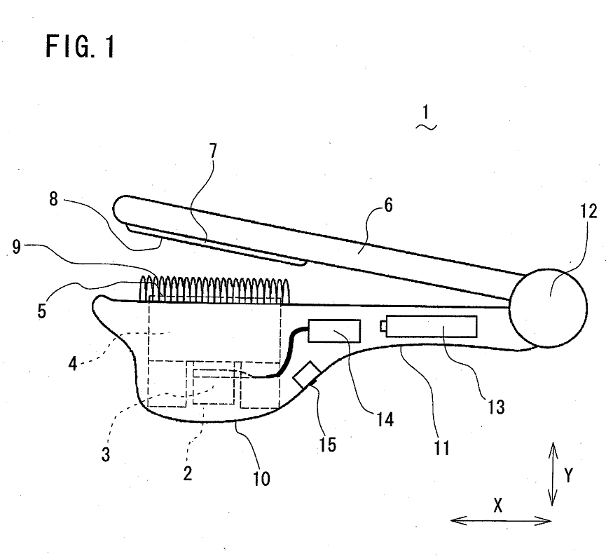

An ultrasonic wave hair set apparatus in accordance with a first embodiment of the present invention is described with reference to figures. As shown in FIG. 1, the ultrasonic wave hair set apparatus in accordance with a first embodiment is configured by a main frame 10 in which a portion near to a rear end thereof serves as a grip 11, an ultrasonic vibration block 2 which is provided in an inside of the main frame 10 near to a front end thereof, a battery 13 and a driving circuit 14 that drives the ultrasonic vibration block 2, an operation switch 15 that controls driving of the ultrasonic vibration block 2, a pinching lever 6 that is rotatably pivoted within a predetermined angle region by a hinge 12 at the rear end of the main frame 10, and a presser plate 7 provided at a position near to the front end of the main frame 10 and to face the ultrasonic vibration block 2, and so on. A front face of the presser plate 7 facing the main frame 10 serves as a pressing face. As for the ultrasonic wave hair set apparatus 1, a thing of type driven with a battery is exemplified, but it may be a thing of the type in which a plug of a power cable is inserted into a plug socket of commercial power supply. In addition, a front end portion of the pinching lever 6 may be biased to depart from the front end portion of the main frame 10 by a spring member (not illustrated), for example.

The ultrasonic vibration block 2 further comprises an ultrasonic transducer 3 which generates ultrasonic vibrations by energization and an ultrasonic horn 4 which is connected with the ultrasonic transducer 3, amplitude the vibrations generated by the ultrasonic transducer 3 and expands vibration area. A surface of the ultrasonic horn 4 serves as a vibration face 5, and it protrudes toward the pinching lever 6 from an upper face of the main frame 10 near to the front end thereof, and disposed to face the pressing face 8 of the above mentioned presser plate 7.

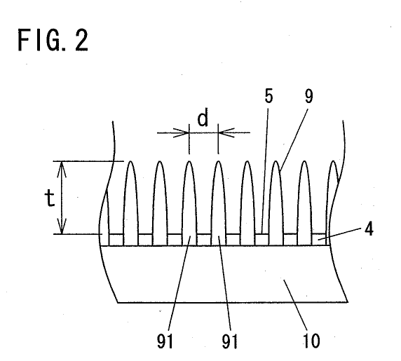

A cross section of the main frame 10 in a direction parallel to a rotational axis of the hinge 12 (that is, a direction parallel to the paper sheet) is substantially rectangular shape which is oblong in a longitudinal direction X of the main frame 10. Similarly, the vibration face 5 of the ultrasonic horn 4 is a substantially rectangular shape which is oblong in the longitudinal direction X of the main frame 10. A pair of comb shaped protection members 9 is provided to enclose the vibration face 5 along both sides of the vibration face 5 of the ultrasonic horn 4 in the longitudinal direction. As shown in FIG. 2, the protection member 9 has a plurality of protection protrusions 91 which are arranged with a predetermined distance “d” around the vibration face 5, and serves as a burn injury prevention means that prevents a portion of a human body other than hairs (typically a finger 31) from touching with the vibration face 5. As an example, it is preferable to select a distance “d” between adjoining two protection protrusions 91 about 2 to 5 mm (d=2˜5 mm), and a protruding height “t” of an apex of each protection protrusion 91 from the vibration face about 5 mm (t=5 mm). In addition, it is preferable to elect a distance “w” between a pair of the protection members 91 disposed on both side of the vibration face 5 at the front end of the ultrasonic horn 4 about 3 to 10 mm (w=3˜10 mm).

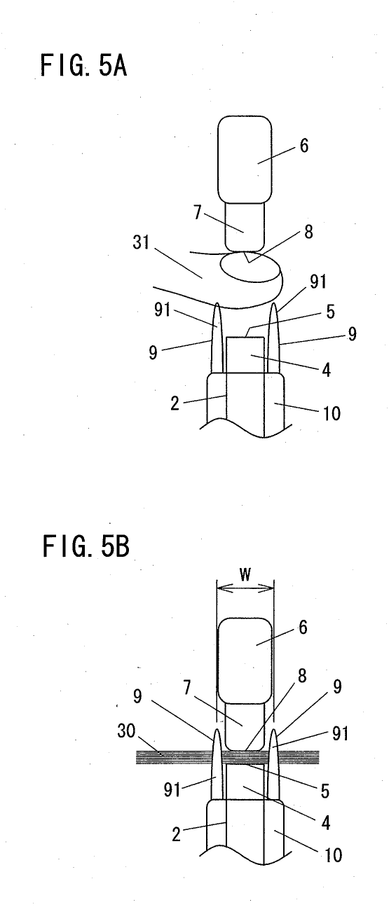

A pair of the protection members 91 may be formed and attached to the main frame 10 as individual subjects, respectively. Alternatively, a pair of the protection members 91 may be formed and attached to the main frame 10 integrally so that stem portions of the protection protrusions 91 are to be a substantially rectangular frame. Alternatively, a pair of the protection members 91 may be formed integrally with the main frame 10. In addition, as shown in FIG. 5B, the pressing face 8 of the presser plate 7 of the pinching lever 6 is formed so that it does not contact with a pair of the protection members 9 of the main frame 10, but contacts only the vibration face 5 of the ultrasonic horn 4 or a bundle 30 of hairs thereon.

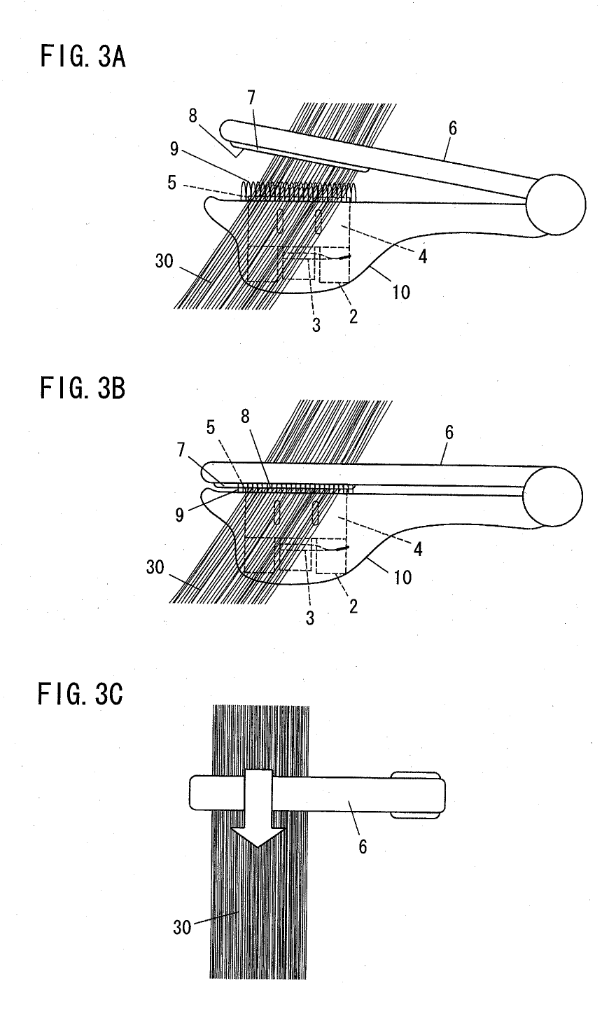

Subsequently, a method to use the ultrasonic wave hair set apparatus is described. As shown in FIG. 3A, a bundle of hairs 30 is disposed between the vibration face 5 of the ultrasonic horn 4 or the protection members 9 and the pressing face 8 of the presser plate 7 in a manner so that the arrangement direction of the protection protrusions 91 of the protection members 9 crosses at right angle to the direction of the bundle of hairs 30 in a condition that the front end portion of the pinching lever 6 departs from the front end portion of the main frame 10. Then, as shown in FIG. 3B, by grasping the grip 11 of the main frame 10 with the rear end portion of the pinching lever 6 by user's hand, the bundle of hairs 30 is pinched between the vibration face 5 of the ultrasonic horn 4 and the pressing face of the presser plate 7 via the protection members 9. Under such a condition, when the operation switch 15 is switched on, the ultrasonic oscillator 3 is driven to generate the ultrasonic vibrations. Alternatively, under a condition that the ultrasonic vibrations are generated by the ultrasonic oscillator 3 by switching on of the operation switch 15 previously, the bundle of hairs 30 may be pinched between the vibration face 5 of the ultrasonic horn 4 and the pressing face of the presser plate 7.

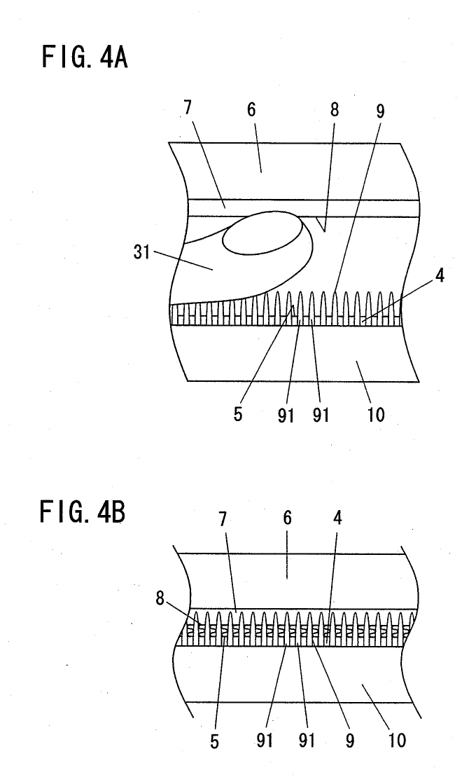

As shown in FIG. 4B, in the condition that the bundle of hairs 30 is pinched between the vibration face 5 of the ultrasonic horn 4 and the pressing face of the presser plate 7, the ultrasonic vibration generated by the ultrasonic oscillator 3 is transmitted to the vibration face 5 through the ultrasonic horn 4, and further transmitted to the bundle of hairs 30 from the vibration face 5. Since each hair of the bundle of hairs 30 is pressed with a high contact pressure to the vibration face 5 of the ultrasonic horn 4 by the pressing face 8 of the presser plate 7, each hair is vibrated by the ultrasonic vibrations transmitted from the vibration face 5, and thus, heat is generated in each hair. Under such a condition, as shown in FIG. 3C, when the ultrasonic wave hair set apparatus 2 is moved substantially parallel to the bundle of hairs 30, that is, the hairs are combed, tension occurs in each hair held between the arrays of the protection protrusions 91 of the protection members 9 so as to stretch and hold the hair straight. Therefore, each hair is set straight because it is heated under a condition that it is held straight. By performing such a operation to entire of the bundle of hairs 30, the entire of the bundle of hairs 30, which is pinched between the pressing face 8 of the presser plate 7 and the vibration face 5 of the ultrasonic horn 4, is can be set straight.

Subsequently, operation of the protection members 9 is described. As shown in FIG. 4A or FIG. 5A, even if a fingertip 31 is penetrated between the main frame 10 and the pinching lever 6, since a pair of the protection members 9 encloses the vibration face 5 of the ultrasonic horn 4, the fingertip 31 may touch the apexes of the protection protrusions 91 prior to touching the vibration face 5. In addition, since the distance “w” between the pair of the protection members 9 is shorter about 3 to 10 mm, and the protrusion height “t” of the apex of the protection protrusion 91 from the vibration face 5 is higher about 5 mm, as mentioned above, the fingertip 31 rarely touches the vibration face 5 directly in a normal condition that the user penetrates the fingertip 31 between the main frame 10 and the pinching lever 6 unconsciously. Therefore, even if the user penetrates the fingertip 31 between the main frame 10 and the pinching lever 6, the possibility that the ultrasonic vibrations generated by the ultrasonic oscillator 3 and transmitted to the vibration face 5 of the ultrasonic horn 4 is further transmitted to the fingertip 31 becomes much smaller. Consequently, the finger is rarely heated from within and be burned.

Although the ultrasonic wave hair set apparatus 1 in accordance with the first embodiment is configured that the presser plate 7 is provided in a portion near to the front end of the pinching lever 6, and the bundle of hairs 30 is pressed to the vibration face 5 of the ultrasonic horn 4 by the pressing face 8 of the presser plate 7, it is not limited to this configuration. Thus, another configuration may be employed if the bundle of hairs 30 can be pressed to the vibration face 5 of the ultrasonic horn 4. In addition, the pinching lever 6 and the presser plate 7 are not necessarily needed. Similarly to the normal hair brush, the ultrasonic wave hair set apparatus 1 may be moved parallel to the bundle of hairs 30 so as to comb hairs, so that pressure to press the hairs to the vibration face 5 can be ensured by pressure generated by pulling the front end of the bundle of hairs 30 by the user.

### Second Embodiment

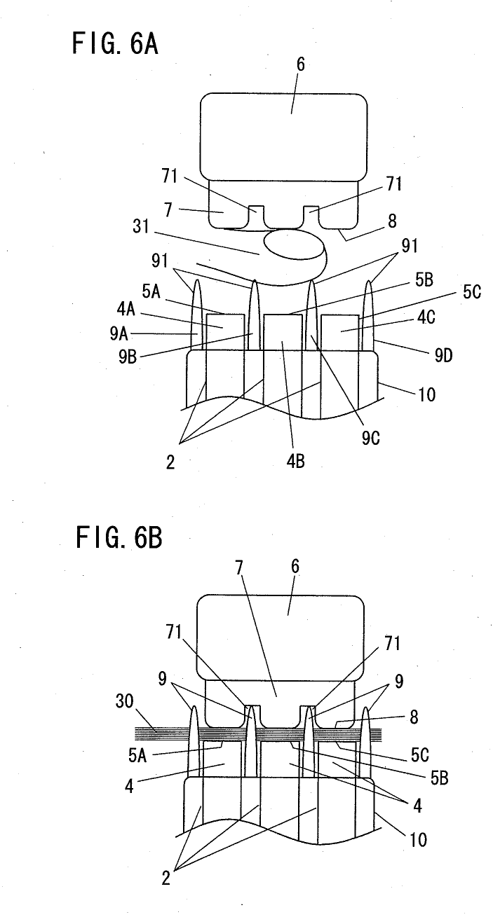

Subsequently, an ultrasonic wave hair set apparatus in accordance with a second embodiment of the present invention is described with reference to FIGS. 6A and 6B. Elements which are the same as or similar to those in the above mentioned first embodiment are designated by the same numerals and the detailed descriptions of them are omitted.

As shown in FIGS. 6A and 6B, an ultrasonic vibration block 2 has a plurality of (three lines in the illustrated example) ultrasonic horns 4A to 4C which are arranged in parallel, and a plurality of vibration faces 5A to 5C on the surfaces of them. Furthermore, a plurality (four in the illustrated example) of comb shaped protection members 9A to 9D is provided along both sides of the vibration faces 5A to 5C in longitudinal directions of them. A plurality of grooves 71 is formed on a presser plate 7 provided at a portion near to a front end of a pinching lever 6 in a longitudinal direction of the presser plate 7 so as to avoid contacting of apexes of protruding protrusions 91 of the protection members 9B and 9C disposed near to the center among the plurality of the protection members 9A to 9D arranged in parallel other than two of them disposed at both sides.

As shown in FIG. 6A, even if the fingertip 31 is penetrated between the main frame 10 and the pinching lever 6, the protection protrusions 91 of the protrusion members 9 respectively enclose the vibration faces 5A to 5D of the ultrasonic horns 4A to 4C, so that the fingertip 31 touches the apexes of the protection protrusions 91 before touching the vibration faces 5A to 5C. Therefore, in the normal condition that the user penetrates the fingertip 31 between the main frame 10 and the pinching lever 6 unconsciously, the fingertip 31 rarely touches the vibration faces 5A to 5D directly, so that the possibility that the ultrasonic vibrations transmitted to the vibration faces 5A to 5C of the ultrasonic horns 4A to 4C is further transmitted to the fingertip 31 becomes much smaller. Consequently, the finger is rarely heated from within and be burned.

On the other hand, as shown in FIG. 6B, when the bundle of hairs 30 is penetrated between the main frame 10 and the pinching lever 6, the bundle of hairs 30 can be pinched between the vibration faces 5A to 5C of the ultrasonic horns 4A to 4C and the pressing face 8 of the presser plate 7, and thus, the ultrasonic vibrations generated by the ultrasonic oscillator 3 can be transmitted to the bundle of hairs 30 through the vibration faces 5A to 5C of the ultrasonic horns 4A to 4C. Consequently, when the hairs are combed by moving the ultrasonic wave hair set apparatus 1 parallel to the bundle of hairs 30, the hairs are set straight.

In addition, the ultrasonic wave hair set apparatus 1 in accordance with the second embodiment is not limited to the above mentioned configuration, so that it is possible to provide presser plates simply at positions of the ultrasonic horns 4A to 4C arranged as three lines other than the ultrasonic horn 4B disposed at the center.

### Third Embodiment

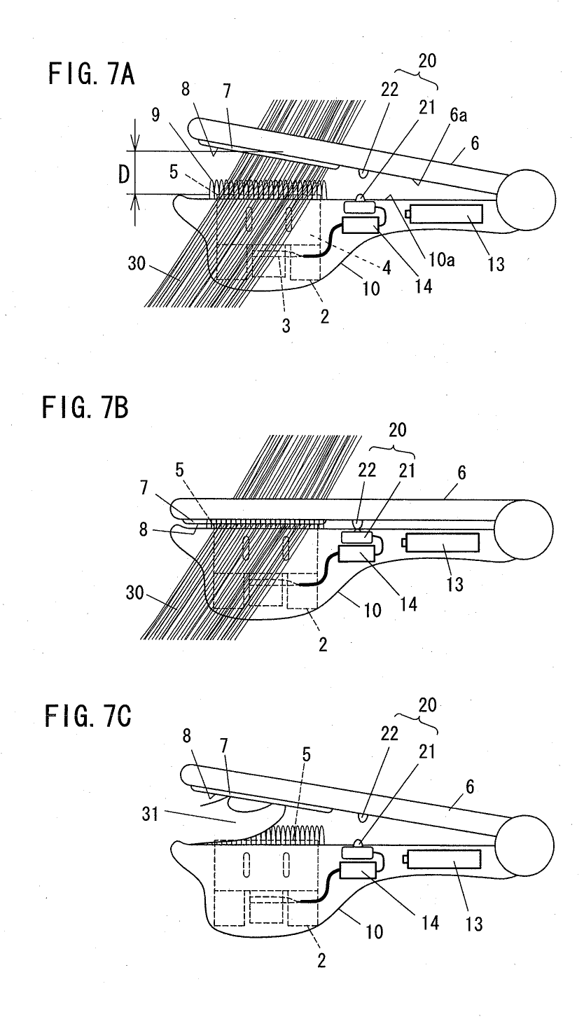

Subsequently, an ultrasonic wave hair set apparatus in accordance with a third embodiment of the present invention is described with reference to FIGS. 7A to 7C. Elements which are the same as or similar to those in the above mentioned first embodiment are designated by the same numerals and the detailed descriptions of them are omitted.

In the third embodiment, a spacing detection sensor 20, which detects a distance “D” between a pressing face 8 of a presser plate 7 of a pinching lever 6 and a vibration face 5 of an ultrasonic horn 4 of a main frame 10 at front end portions of them, is comprised as a safety switch further to protection members 9. As shown in FIG. 7A, the spacing detection sensor 20 is configured by a push-on switch 21 provided on an opposing face 10a of the main frame 10 which faces the pinching lever 6, and a protrusion 22 provided on an opposing face of the pinching lever 6 which face the main frame 10. A protruding height of the protrusion 22 is selected corresponding to the distance “D” between the pressing face 8 of the presser plate 7 and the vibration face 5 of the ultrasonic horn 4.

As shown in FIG. 7B, when the protrusion 22 touches the switch 21 and the switch 21 is switched on, the distance “D” between the pressing face 8 of the presser plate 7 and the vibration face 5 of the ultrasonic horn 4 becomes equal to or less than a predetermined distance by which a finger of a user cannot penetrate therethrough, so that a driving circuit 14 drives an ultrasonic oscillator 3 by supplying an electric power so as to generate ultrasonic vibrations. As for the above mentioned predetermined distance is preferably about 5 mm, for example.

On the other hand, as shown in FIG. 7C, when a fingertip 31 penetrates between the main frame 10 and the pinching lever 6, the protrusion 22 cannot touch the switch 21, so that the switch 21 may not be switched on. Thus, the driving circuit 14 does not supply the electric power to the ultrasonic oscillator 3, and the ultrasonic oscillator 3 does not generate ultrasonic vibration. Consequently, since no ultrasonic vibration is transmitted to the fingertip 31, the finger may not be heated from within and the finger never be burned.

### Fourth Embodiment

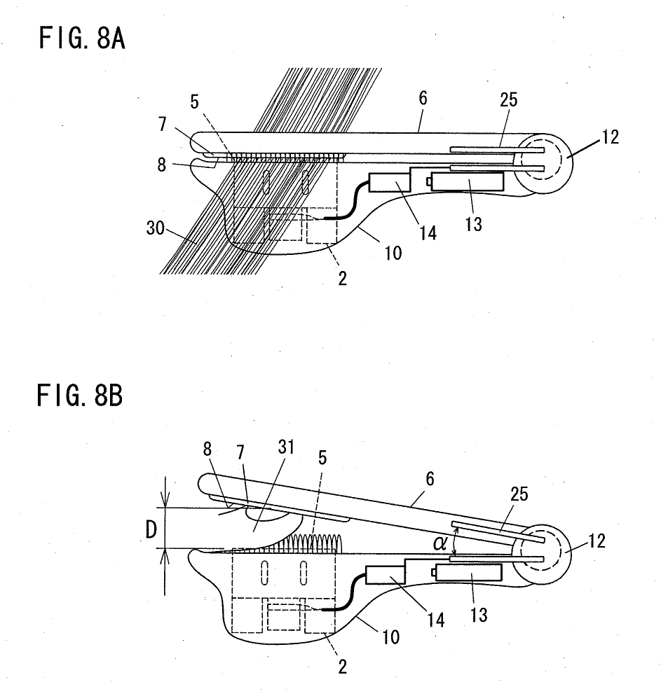

Subsequently, an ultrasonic wave hair set apparatus in accordance with a fourth embodiment of the present invention is described with reference to FIGS. 8A and 8B. Elements which are the same as or similar to those in the above mentioned third embodiment are designated by the same numerals and the detailed descriptions of them are omitted.

In the fourth embodiment, an angle detection sensor 25, which detects an angle α between a pressing face 8 of a presser plate 7 of a pinching lever 6 and a vibration face 5 of an ultrasonic horn 4 of a main frame 10 at front end portions of them, is provided as a safety switch further to protection members 9. As shown in FIG. 8A, the angle detection sensor 25 is provided in an inside of a hinge 12, and configured of a moving contact and a stationary contact which are electrically conducted when the angle α of the pinching lever 6 with respect to the main frame 10 becomes equal to or less than a predetermined angle.

As shown in FIG. 8A, in a condition that a bundle of hairs 30 is pinched between the pressing face 8 of the presser plate 7 and the vibration face 5 of the ultrasonic horn 4, a distance between the pressing face 8 of the presser plate 7 and the vibration face 5 of the ultrasonic horn 4 becomes equal to or less than a predetermined distance by which a finger of a user cannot penetrate therethrough, so that the angle detection sensor 25 is switched on, and a driving circuit 14 drives an ultrasonic oscillator 3 by supplying an electric power so as to generate ultrasonic vibrations. Since the predetermined angle varies corresponding to allover lengths of the main frame 10 and the pinching lever 6, specific numerical value is nor exemplified, but it is preferable to select an angle by which a distance “D” between the pressing face 8 of the presser plate 7 and the vibration face 5 of the ultrasonic horn 4 of at front end portions of them becomes about 5 mm, for example.

On the other hand, as shown in FIG. 8B, when a fingertip 31 penetrates between the main frame 10 and the pinching lever 6, the moving contact and the stationary contact cannot touch each other, so that the angle detection sensor 25 may not be switched on. Thus, the driving circuit 14 does not supply the electric power to the ultrasonic oscillator 3, and the ultrasonic oscillator 3 does not generate ultrasonic vibration. Consequently, since no ultrasonic vibration is transmitted to the fingertip 31, the finger may not be heated from within and the finger never be burned.

In addition, as for the angle detection sensor 25, an optical encoder which is configured by a light emitting device, a light receiving device, a grating plate, and so on can be used other than the electronic switch. In such case, the driving circuit 14 counts pulse signals outputted from the angle detection sensor 25, calculates an angle α of the pinching lever 6 with respect to the main frame 10, and compares the calculated angle α with a predetermined angle.

### Fifth Embodiment

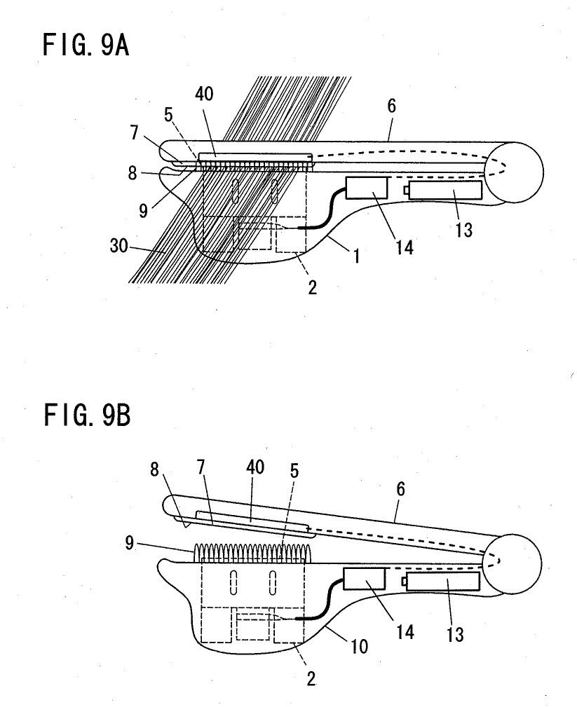

Subsequently, an ultrasonic wave hair set apparatus in accordance with a fifth embodiment of the present invention is described with reference to FIGS. 9A and 9B. Elements which are the same as or similar to those in the above mentioned first embodiment are designated by the same numerals and the detailed descriptions of them are omitted.

In the fifth embodiment, a pressure sensor 40, which detects a pressure applied to a pressing face 8, is provided at a position in an inside of a pinching lever 8 and in a rear face side of a presser plate 7. Only when a detection result of the pressure sensor 40 becomes equal to or larger than a predetermined pressure, a driving circuit 14 drives an ultrasonic oscillator 3 by supplying an electric power so as to generate ultrasonic vibrations. As for the above mentioned predetermined pressure, it is preferable to be set in 2 kgf, for example.

The pressure sensor 40 has a following merit further to functions as a safety switch and a burn prevention means. For example, as shown in FIG. 9, even if a bundle of hairs 30 is pinched between a pressing face 8 and a vibration face 5 of an ultrasonic horn 4, when a force of a user to grasp a grip 11 of the pinching lever 6 and the main frame 10 is weak, that is, a pressure to press the vibration face 5 by the pressing face 8 is insufficient, generation of ultrasonic vibration is restricted. Consequently, it is possible to prevent so-called null oscillation (boil-dry) in which the ultrasonic vibrations are generated in a condition that hairs are pressed to the vibration face insufficiently. Such null oscillation is a condition that the ultrasonic horn 4 is oscillated in or near to no-load, so that heat is generated in the ultrasonic horn 4 due to energy loss, and it may cause breakdown if the apparatus. In contrast, according to the fifth embodiment, the breakdown of the apparatus due to such null oscillation can be prevented.

The present invention is not limited to the above mentioned embodiments, and it is preferable to comprise at least a main frame, an ultrasonic vibration generating means which is provided on the main frame and generates ultrasonic vibrations, and a burn injury prevention means that prevent a portion of a human body other than hairs from touching the vibration face of the ultrasonic wave generating means.

By providing the burn injury prevention means, even if a user touches a portion of a human body other than hairs such as a finger to the ultrasonic vibration generating means of the ultrasonic wave hair set apparatus in long time, the ultrasonic vibration may not be transmitted to the portion of the human body, so that the finger may not be heated from within and the finger may not be burnt injury.

In addition, the burn injury prevention means may be a comb shaped protection member which is provided along a side face of the vibration face. Since the protection member is formed comb shape, it is possible not only to comb hairs as a brush, but also to provide a stimulus to a portion of a human body when the portion of the human body such as a finger touches the protection member. Therefore, it is thought that a user takes off the portion of the human body from the vibration face quickly, so that even if the portion of the human body touches the vibration face directly, a contacting time can be shortened. Consequently, ultrasonic vibrations transmitted to the portion of the human body is few, so that a finger rarely heated from within, and the finger is never burned.

Furthermore, the ultrasonic vibration generating means may be configured by an ultrasonic oscillator, and an ultrasonic horn connected to the ultrasonic oscillator and having a rectangular shaped vibration face, and a pair of comb shaped protection members is provided parallel to each other along both sides of the rectangular vibration face in a longitudinal direction thereof. Since the vibration face is guarded from both sides by a pair of the comb shaped protection members, it is possible to increase the above mentioned functions as the brush and the burn injury prevention means.

Furthermore, it may further comprise a pressing means having a pressing face to press hairs to the vibration face, and the pressing means may be configured so as not to interfere with the comb shaped protection member in a condition that the hairs are pressed to the vibration face. Since the hair is strongly pressed to the vibration face by the pressing means, the ultrasonic vibration can be transmitted to the hairs efficiently. Consequently, hair set effect by the ultrasonic vibrations can be increased.

Alternatively, it may further comprise a pressing means having a pressing face to press hairs to the vibration face, and a safety switch as the burn injury prevention means, which makes the ultrasonic vibration generating means generate ultrasonic vibrations only when a distance between the pressing face and the vibration face becomes equal to or less than a predetermined distance. If a portion of a human body such as a finger is pinched between the pressing face and the vibration face, the distance between them becomes longer than the predetermined distance. In such case, ultrasonic vibration is never generated by an operation of the safety switch when a portion of a human body such as a finger is pinched between the pressing face and the vibration face, and thus, the user is never burned.

In addition, the pressing means may be configured by a pinching lever which is rotatably held on the main frame and a presser plate which is provided on the pinching lever; the ultrasonic vibration generating means may be configured by an ultrasonic oscillator, and an ultrasonic horn connected to the ultrasonic oscillator; and the safety switch may be configured by a distance detection sensor which detects a distance between a pressing face of the presser plate and a vibration face of the ultrasonic horn, and a driving circuit which drives the ultrasonic vibration generating means to generate ultrasonic vibration only when the distance detected by the distance detection sensor becomes equal to or less than a predetermined distance. By providing the distance detection sensor (switch) which cannot turn on if the distance between the pressing face and the vibration face does not become equal to or less than the predetermined distance is provided, for example, a reliable safety switch can be configured with using a relatively simple and inexpensive element.

Alternatively, the pressing means may be configured by a pinching lever which is rotatably held on the main frame and a presser plate which is provided on the pinching lever; the ultrasonic vibration generating means may be configured by an ultrasonic oscillator, and an ultrasonic horn connected to the ultrasonic oscillator; and the safety switch may be configured by an angle detection sensor which detects an angle of the pinching lever with respect to the main frame, and a driving circuit which drives the ultrasonic vibration generating means to generate ultrasonic vibration only when the angle detected by the angle detection sensor becomes equal to or less than a predetermined angle. By providing the angle detection sensor (switch) which cannot turn on if the angle between the pinching lever and the main frame does not become equal to or less than the predetermined angle is provided, for example, a reliable safety switch can be configured with using a relatively simple and inexpensive element.

Furthermore, it may comprise a pressing means having a pressing face which presses hairs to a vibration face; a pressure detection sensor which detects a pressure applied to the pressing face; and a driving circuit which drives the ultrasonic vibration generating means to generate ultrasonic vibrations only when a pressure detected by the pressure detection sensor becomes equal to or larger than a predetermined pressure. By providing a pressure sensor such as a piezoelectric device on a rear face of the pressing face, for example, a reliable safety switch can be configured with using a relatively simple and inexpensive element.

This pressure detection sensor can be used as the above mentioned safety switch. In other words, even if a portion of a human body such as a fingertip is pinched between the pressing face and the vibration face, the ultrasonic vibrations are never generated when the user does not apply a pressure equal to or larger than the predetermined pressure purposely. However, if a pressure equal to or larger than the predetermined pressure is applied between the pressing face and the vibration face, stimulus may be applied to the portion of the human body pinched between the pressing face and the vibration face, so that the user may take off the portion from between the pressing face and the vibration face. Consequently, the user can be prevented from burn injury.

In addition, when the ultrasonic vibrations are generated in a condition that a pressure for pressing the vibration face by the pressing face is insufficient, the ultrasonic horn may be oscillated in or near to no-load, so that heat is generated in the ultrasonic horn due to energy loss, and thus, it may cause breakdown of the apparatus (so-called null vibration or boil-dry). However, since the ultrasonic vibration may not be generated by the pressure detection sensor if the pressure equal to or larger than the predetermined pressure is applied between the pressing face and the vibration face, it is possible to prevent the breakdown of the apparatus due to null vibration.

Furthermore, the ultrasonic wave hair set apparatus may be configured in combination with the above mentioned elements arbitrarily.

This application is based on Japanese patent application 2005-341251 filed in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. An ultrasonic wave hair set apparatus comprising:
a main frame;
an ultrasonic vibration generating means which is provided on the main frame and generates ultrasonic vibrations; and
a burn injury prevention means that prevents a portion of a human body other than hairs from touching the vibration face of the ultrasonic wave generating means.

2. The ultrasonic wave hair set apparatus in accordance with claim 1, wherein the burn injury prevention means is comb shaped protection members which are provided along side faces of the vibration face.

3. The ultrasonic wave hair set apparatus in accordance with claim 2, wherein the ultrasonic vibration generating means may be configured by an ultrasonic oscillator, and an ultrasonic horn connected to the ultrasonic oscillator and having a rectangular shaped vibration face, and a pair of comb shaped protection members is provided parallel to each other along both sides of the rectangular vibration face in a longitudinal direction thereof.

4. The ultrasonic wave hair set apparatus in accordance with claim 3 further comprising a pressing means having a pressing face to press hairs to the vibration face, and wherein
the pressing means is configured so as not to interfere with the comb shaped protection member in a condition that the hairs are pressed to the vibration face.

5. The ultrasonic wave hair set apparatus in accordance with claim 1 further comprising:
a pressing means having a pressing face to press hairs to the vibration face; and
a safety switch as the burn injury prevention means, which makes the ultrasonic vibration generating means generate ultrasonic vibrations only when a distance between the pressing face and the vibration face becomes equal to or less than a predetermined distance.

6. The ultrasonic wave hair set apparatus in accordance with claim 5, wherein
the pressing means is configured by a pinching lever which is rotatably held on the main frame and a presser plate which is provided on the pinching lever;
the ultrasonic vibration generating means is configured by an ultrasonic oscillator, and an ultrasonic horn connected to the ultrasonic oscillator; and
the safety switch is configured by a distance detection sensor which detects a distance between a pressing face of the presser plate and a vibration face of the ultrasonic horn, and a driving circuit which drives the ultrasonic vibration generating means to generate ultrasonic vibration only when the distance detected by the distance detection sensor becomes equal to or less than a predetermined distance.

7. The ultrasonic wave hair set apparatus in accordance with claim 5, wherein
the pressing means is configured by a pinching lever which is rotatably held on the main frame and a presser plate which is provided on the pinching lever;
the ultrasonic vibration generating means is configured by an ultrasonic oscillator, and an ultrasonic horn connected to the ultrasonic oscillator; and
the safety switch is configured by an angle detection sensor which detects an angle of the pinching lever with respect to the main frame, and a driving circuit which drives the ultrasonic vibration generating means to generate ultrasonic vibration only when the angle detected by the angle detection sensor becomes equal to or less than a predetermined angle.

8. The ultrasonic wave hair set apparatus in accordance with claim 1 further comprising:
a pressing means having a pressing face which presses hairs to a vibration face;
a pressure detection sensor which detects a pressure applied to the pressing face; and
a driving circuit which drives the ultrasonic vibration generating means to generate ultrasonic vibrations only when a pressure detected by the pressure detection sensor becomes equal to or larger than a predetermined pressure.
